(19) United States
(12) Patent Application Publication
(10) Pub. No.: US 2015/0268341 A1
(43) Pub. Date: Sep. 24, 2015

(54) OBJECT DETECTION USING ULTRASONIC PHASE ARRAYS

(71) Applicant: Ford Global Technologies, LLC, Dearborn, MI (US)

(72) Inventors: Christos Kyrtsos, Beverly Hills, MI (US); Thomas Edward Pilutti, Ann Arbor, MI (US); Alex Maurice Miller, Canton, MI (US)

(73) Assignee: Ford Global Technologies, LLC, Dearborn, MI (US)

(21) Appl. No.: 14/221,632

(22) Filed: Mar. 21, 2014

(51) Int. Cl. G01S 15/93; G01S 7/539; G01S 7/524

(52) U.S. Cl. CPC G01S 15/931; G01S 7/524; G01S 7/539; G01S 2015/938

(57) ABSTRACT

A vehicle includes a fascia, a sensor array disposed on the fascia, and a processing device. The sensor array has a plurality of ultrasonic sensors, each configured to output a sensor signal. The processing device is configured to process the sensor signals and control operation of the sensor array to generate a three dimensional image of an object near the vehicle based at least in part on the sensor signals.

### BACKGROUND

Sensors help vehicle control modules execute a number of vehicle operations. Sensors have become so sophisticated that some vehicles are able to operate autonomously (i.e., with no or limited driver interaction). Some vehicles implement the concept of sensor fusion. That is, readings from multiple sensors, including different types of sensors, can be combined to provide a deeper understanding of the environment in and around the vehicle.

### BRIEF DESCRIPTION OF THE DRAWINGS

FIG. 1 illustrates an exemplary vehicle having an ultrasonic sensor array.

FIG. 2 is a block diagram of an exemplary system that may be implemented in the vehicle of FIG. 1.

FIGS. 3A-3C illustrate exemplary sensor arrays with dynamic beam focusing.

FIG. 4 illustrates an exemplary image generated by the system of FIG. 2 and shown on a user interface device.

### DETAILED DESCRIPTION

An exemplary vehicle includes a fascia, a sensor array disposed on the fascia, and a processing device. The sensor array has a plurality of ultrasonic sensors, each configured to output a sensor signal. The processing device is configured to process the sensor signals and control operation of the sensor array to generate a three dimensional image of an object near the vehicle based at least in part on the sensor signals. The three dimensional image may be presented to a vehicle occupant via, e.g., a user interface device. Thus, the occupant may see three dimensional depictions of objects around the vehicle, such as behind the vehicle, without the use of an external camera. Alternatively or in addition, the image can be processed and fed into other vehicle features and/or sensors.

The vehicle and system shown in the FIGS. may take many different forms and include multiple and/or alternate components and facilities. The exemplary components illustrated are not intended to be limiting. Indeed, additional or alternative components and/or implementations may be used.

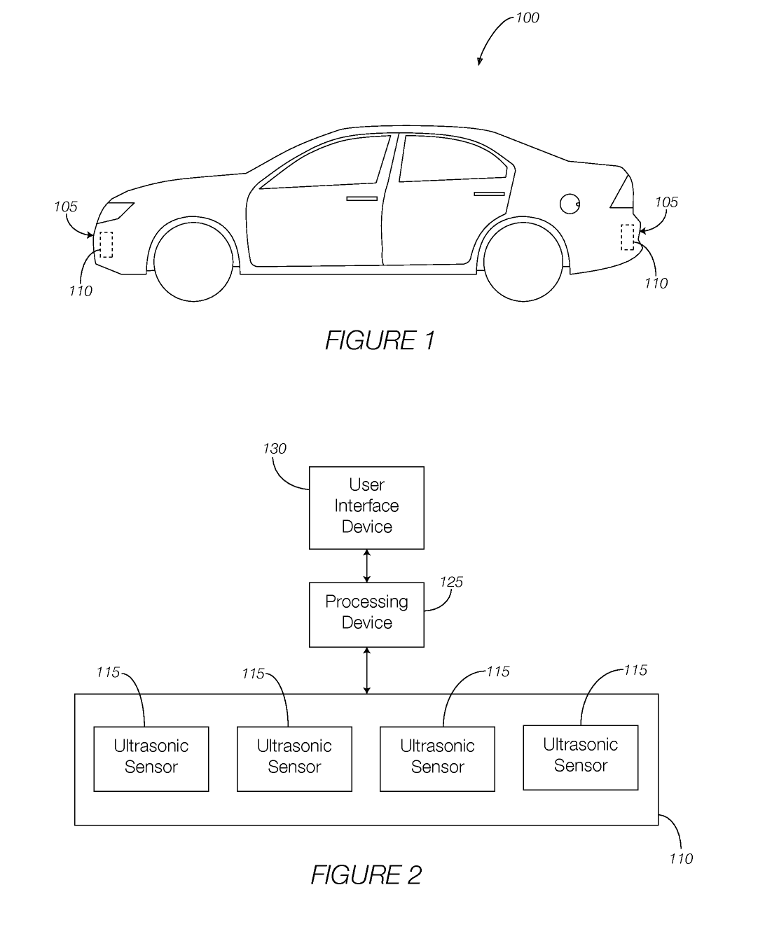

As illustrated in FIG. 1, the vehicle 100 includes a fascia 105 and a sensor array 110. Although illustrated as a sedan, the vehicle 100 may include any passenger or commercial vehicle such as a car, a truck, a sport utility vehicle, a taxi, a bus, etc.

The fascia 105 may refer to a cover located at the front and/or rear ends of the vehicle 100. The fascia 105 may be generally formed from a plastic material, and in some instances, the fascia 105 may have aesthetic qualities that define the shape of the front- and/or rear-ends of the vehicle 100. Further, the fascia 105 may hide certain parts of the vehicle 100, such as the bumper, from ordinary view. The fascia 105 may define various openings for, e.g., headlamps, a grille, tail lamps, fog lamps, sensors, etc.

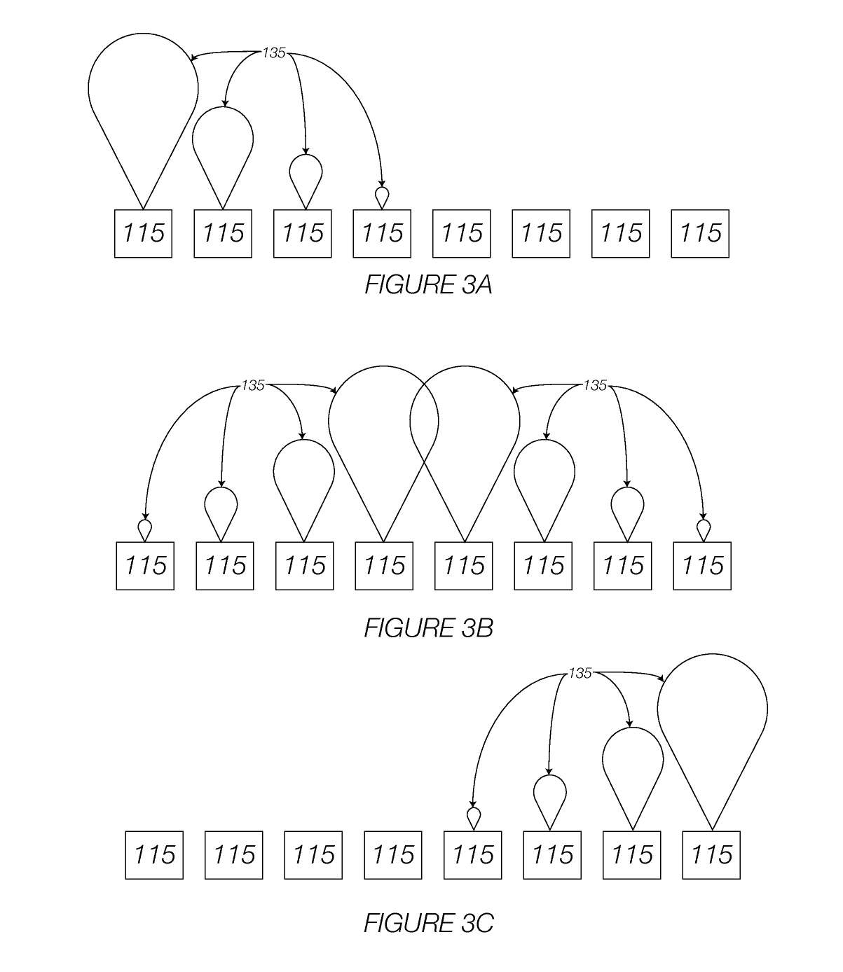

The sensor array 110 may include any number of sensors configured to generate signals that help operate the vehicle 100. The vehicle 100 may include any number of sensor arrays 110. One sensor array 110 may be located near a front of the vehicle 100 to detect objects in front of the vehicle 100 while another sensor array 110 may be located near a rear of the vehicle 100 to detect objects behind the vehicle 100. The sensor array 110 may include, for example, multiple ultrasonic sensors 115 (see FIGS. 2, and 3A-C) that output sensor signals that represent objects in front of and/or behind the vehicle 100, depending on the location of the ultrasonic sensors 115. In one possible approach, one or more of the ultrasonic sensors 115 may be disposed on the fascia 105. Alternatively or in addition, one or more ultrasonic sensors 115 may be located behind the fascia 105, that is, hidden from ordinary view. The ultrasonic sensors 115 may be disposed in a linear array, a circular array, a semicircular array, or any other configuration, including more complex configurations. Moreover, each ultrasonic sensor 115 may be configured to operate in a range of frequencies. For instance, the ultrasonic sensors 115 may each be configured to operate in a frequency range of approximately 50 kHz to 1.2 MHz. The ultrasonic sensors 115 need not all be operated at the same frequency within the range. Thus, one ultrasonic sensor 115 may be operated at a higher frequency than at least one other ultrasonic sensor 115.

FIG. 2 is a block diagram of an exemplary system 120 for controlling the ultrasonic sensors 115 in the sensor array 110. The system 120 includes a processing device 125 in communication with each of the ultrasonic sensors 115. The processing device 125 may be configured to control the operation of the sensor array 110 to generate a three dimensional image of an object near the vehicle 100. To create the three dimensional image, the sensor array 110 may be a 2×N array or larger (e.g., 3×N, 4×N, etc.), or some sensors in the array 110 may be configured to scan the equivalent of multiple (e.g., at least two) rows. The operation of the sensor array 110 may be controlled according to the sensor signals received by the processing device 125. The processing device 125 may control the operation of the sensor array 110 by individually controlling each ultrasonic sensor 115. For instance, the processing device 125 may be configured to separately pulse each ultrasonic sensor 115 instead of pulsing the ultrasonic sensors 115 collectively. Moreover, the processing device 125 may be configured to implement a beam sweeping technique to, e.g., sweep a beam of the sensor array 110 through a plurality of refracted angles. Alternatively or in addition, the processing device 125 may be configured to control the operation of the sensor array 110 by dynamically focusing a beam (see FIGS. 3A-3C) of the sensor array 110 to different distances relative to the sensor array 110. The processing device 125 may be configured to process the sensor signals by, e.g., processing the signals along a linear path.

The system 120 may further include a user interface device 130. The user interface device 130 may be configured to present information to and/or receive inputs from a user, such as a driver, during operation of the vehicle 100. Thus, the user interface device 130 may be located in the passenger compartment of the vehicle 100. In some possible approaches, the user interface device 130 may include a touch-sensitive display screen. In one possible approach, the user interface device 130 may be configured to receive signals output by the processing device 125. The signals received by the user interface device 130 may represent the processed sensor signals. Thus, the user interface device 130 may be used to view depictions of objects located in front of or behind the vehicle 100.

FIGS. 3A-3C show sensor arrays 110 with dynamic beam focusing. The sensor arrays 110 illustrated in FIGS. 3A-3C have eight ultrasonic sensors 115 per row (only one row shown for clarity), although other numbers of ultrasonic sensors 115, possibly as few as 2 sensors 115 in each row, may be used. The ultrasonic sensors 115 are arranged in a linear array. In other possible approaches, the ultrasonic sensors 115 may be arranged in a circular array, a semicircular array, or any other non-linear configuration. Each ultrasonic sensor 115 may be configured to transmit and/or receive sound waves. Moreover, each ultrasonic sensor 115 that is configured to receive sound waves, such as sound waves that reflect off of detected objects, may be configured to output a sensor signal representing the distance to the object. In FIG. 3A, the beam 135 of the sensor array 110 is aimed toward a rear passenger side of the vehicle 100. Aiming the beam 135 may include adjusting the power of the broadcast to form a peak broadcast followed by lower-level broadcasts as the aiming is directed from, e.g., left to right. Aiming can be achieved by increasing or reducing the power levels of the sensor 115, frequency changes, and/or removing power from one or more of the sensors 115 as objects are scanned. In FIG. 3B, the beam 135 of the sensor array 110 is aimed directly behind the vehicle 100. In FIG. 3C, the beam 135 is aimed toward a rear driver's side of the vehicle 100. The strength and directions of the beams 135 shown in FIGS. 3A-3C may represent different ways the beam 135 may be focused at different times as the system 120 attempts to identify and depict objects in the vicinity of the vehicle 100.

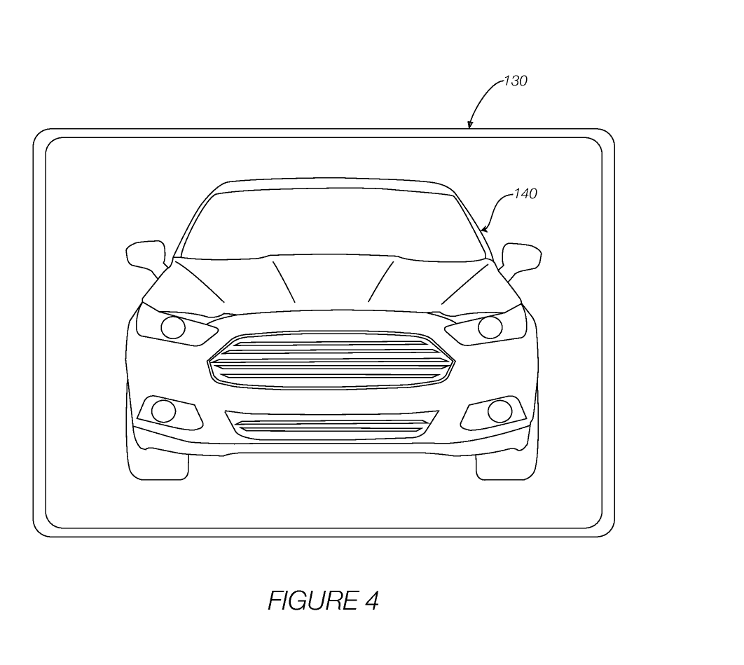

FIG. 4 is an exemplary image 400 of an object 140 detected by the system 120 that may be presented to an occupant of the vehicle 100 via, e.g., the user interface device 130. The object 140 in FIG. 4 is a vehicle detected by the system 120. As discussed above, each ultrasonic sensor 115 may transmit sound waves to and/or receive sound waves reflected from the object 140. Each ultrasonic sensor 115 may generate a sensor signal representing the sound wave received. The processing device 125 may determine the shape of the object 140 from the sensor signals received. As discussed above, the processing device 125 may be configured to separately pulse each ultrasonic sensor 115 instead of pulsing the ultrasonic sensors 115 collectively. Moreover, the processing device 125 may be configured to implement a beam 135 sweeping technique to, e.g., sweep a beam 135 of the sensor array 110 through a plurality of refracted angles, which may help the processing device 125 determine the three dimensional shape of the object 140. Alternatively or in addition, the processing device 125 may develop the three dimensional image by dynamically focusing a beam 135 of the sensor array 110 to different distances relative to the sensor array 110. Once the sensor signals have been processed, the processing device 125 may output the image 400 to the user interface device 130, which may present the image to the driver or another occupant.

In general, computing systems and/or devices, such as the processing device 125 and the user interface device 130, may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle comprising:
a fascia;
a sensor array disposed on the fascia, the sensor array having a plurality of ultrasonic sensors, each configured to output a sensor signal;
a processing device configured to process the sensor signals and control operation of the sensor array to generate a three dimensional image of an object near the vehicle based at least in part on the sensor signals.

2. The vehicle of claim 1, wherein each of the ultrasonic sensors is individually controlled by the processing device.

3. The vehicle of claim 2, wherein individually controlling the ultrasonic sensors includes separately pulsing each of the ultrasonic sensors.

4. The vehicle of claim 1, wherein the sensor array includes at least one of a linear array and a circular array.

5. The vehicle of claim 1, wherein each of the ultrasonic sensors operates in a frequency range of approximately 50 kHz to 1.2 MHz.

6. The vehicle of claim 1, wherein controlling operation of the sensor array includes sweeping a beam of the sensor array through a plurality of refracted angles.

7. The vehicle of claim 1, wherein processing the sensor signals includes processing the sensor signals along a linear path.

8. The vehicle of claim 1, wherein controlling operation of the sensor array includes dynamically focusing a beam of the sensor array to different distances relative to the sensor array.

9. The vehicle of claim 1, wherein the sensor array is configured to detect an object behind the vehicle.

10. The vehicle of claim 1, wherein the sensor array is configured to detect an objected in front of the vehicle.

11. A vehicle system comprising:
a sensor array having a plurality of ultrasonic sensors, each configured to output a sensor signal;
a processing device configured to process the sensor signals and control operation of the sensor array to generate a three dimensional image of an object near the vehicle based at least in part on the sensor signals.

12. The vehicle system of claim 11, wherein each of the ultrasonic sensors is individually controlled by the processing device.

13. The vehicle system of claim 12, wherein individually controlling the ultrasonic sensors includes separately pulsing each of the ultrasonic sensors.

14. The vehicle system of claim 11, wherein the sensor array includes at least one of a linear array and a circular array.

15. The vehicle system of claim 11, wherein each of the ultrasonic sensors operates in a frequency range of approximately 50 kHz to 1.2 MHz.

16. The vehicle system of claim 11, wherein controlling operation of the sensor array includes sweeping a beam of the sensor array through a plurality of refracted angles.

17. The vehicle system of claim 11, wherein processing the sensor signals includes processing the sensor signals along a linear path.

18. The vehicle system of claim 11, wherein controlling operation of the sensor array includes dynamically focusing a beam of the sensor array to different distances relative to the sensor array.

19. The vehicle system of claim 11, wherein the sensor array is configured to detect an object behind a vehicle.

20. The vehicle system of claim 11, wherein the sensor array is configured to detect an objected in front of a vehicle.
